(19) United States
(12) Patent Application Publication
(10) Pub. No.: US 2009/0134202 A1
(43) Pub. Date: May 28, 2009

(54) REFLOW APPARATUS AND METHOD

(75) Inventors: Min-Ill KIM, Chungcheongnam-do (KR); Il-Young HAN, Gyeonggi-do (KR); Ki-Kwon JEONG, Chungcheongnam-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 12/324,458

(22) Filed: Nov. 26, 2008

(30) Foreign Application Priority Data
Nov. 26, 2007 (KR) 10-2007-0120844

(51) Int. Cl. B23K 37/00; H05B 6/04

(52) U.S. Cl. 228/47.1; 219/660

(57) ABSTRACT

Provided are a reflow apparatus and method. The reflow apparatus includes a loader unit, a heating unit, an unloader unit, and a moving unit. The loader unit has an input module and an input stacker. Processing objects are stored in vertical stacks in magazines, and a plurality of magazines is stored in the input stacker. The magazines stored in the input stacker are moved to the input module and are introduced into the heating unit by the moving unit. Solder balls provided on the processing objects within the heating unit are quickly processed using an induction heating method. The processing objects that have undergone a reflow process are loaded in a magazine on an output module of the unloader unit and are then stored in an output stacker.

### CROSS-REFERENCE TO RELATED APPLICATIONS

This U.S. non-provisional patent application claims priority under 35 U.S.C. §119 to Korean Patent Application No. 10-2007-0120844, filed on Nov. 26, 2007, the entire contents of which are hereby incorporated by reference.

### BACKGROUND

The present inventive concept disclosed herein relates to a semiconductor manufacturing apparatus and method, and more particularly, to a reflow apparatus and method for performing reflow of solder balls in a packaging process.

Semiconductor packaging includes, among other things, an assembling process and a mounting process. The assembling process includes providing and assembling solder balls that function as terminals for electrically connecting a semiconductor chip to external circuitry. The mounting process includes mounting the semiconductor chip provided with the solder balls onto a printed circuit board (PCB). Both the assembly process and the mounting process include a reflow step for the solder balls, which is performed by applying heat to the solder balls. The reflow step can take significant time and thus reduce the throughput of the packaging process. Consequently, a need remains for a high-throughput reflow process.

### SUMMARY

Embodiments of the present inventive concept provide apparatuses for performing reflow of external connection terminals provided on a processing object. The reflow apparatus includes a loader unit for storing a plurality of processing objects, a heating unit for heating the processing objects with an induction heating method to perform reflow of external connection terminals provided on the processing objects, a moving unit for moving the processing objects from the loader unit to the heating unit, and an unloader unit for storing those of the processing objects that have undergone a reflow process in the heating unit.

### BRIEF DESCRIPTION OF THE DRAWINGS

The accompanying figures are included to provide a further understanding of the present inventive concept, and are incorporated in and constitute a part of this specification. The drawings illustrate exemplary embodiments of the present inventive concept and, together with the description, serve to explain principles of the present inventive concept. In the figures:

FIG. 1 is a view schematically illustrating the structure of a reflow apparatus according to an embodiment of the present inventive concept;

FIGS. 2 and 3 are exemplary diagrams respectively illustrating processing objects provided to a reflow apparatus according to the present inventive concept;

FIG. 4 is a perspective view of the reflow apparatus of FIG. 1;

FIG. 5 is a perspective view of an exemplary magazine;

FIG. 6 is a cross-sectional view of an input stacker;

FIG. 7 is a cross-sectional view of a pusher for moving a magazine from an input stacker to an input module;

FIG. 8 is a cutaway perspective view of an example of a heating unit;

FIGS. 9 and 10 are perspective views illustrating examples of coils;

FIGS. 11 through 15 are perspective views of different heating members, respectively;

FIGS. 16 and 17 are graphs illustrating the rotations of coils in FIGS. 14 and 15, respectively;

FIGS. 18 and 19 are diagrams illustrating the angles between conductive lines and electromagnetic lines provided to a processing object according to the position of a coil;

FIG. 20 is perspective view of another example of a heating member;

FIG. 21 is a perspective view of a moving unit;

FIG. 22 is a perspective view of another example of a rail;

FIG. 23 is a perspective view illustrating the process of moving a processing object using rails;

FIG. 24 is a perspective view of another example of a magazine;

FIG. 25 is a perspective view illustrating the process of moving a processing object using the magazine of FIG. 24;

FIG. 26 is a view schematically illustrating the structure of a semiconductor reflow apparatus according to another embodiment of the present inventive concept;

FIGS. 27 through 29 are perspective views of different examples of heating units of the reflow apparatus in FIG. 26, respectively; and

FIG. 30 is a view schematically illustrating the structure of a semiconductor reflow apparatus according to a further embodiment of the present inventive concept.

### DETAILED DESCRIPTION OF THE EMBODIMENTS

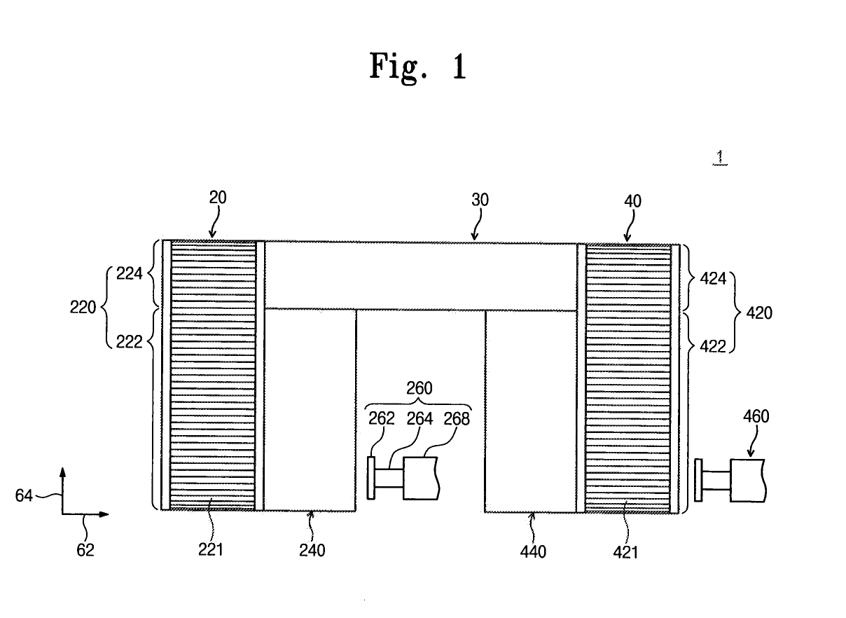

Preferred embodiments of the present inventive concept will be described below in more detail with reference to FIGS. 1 through 30. The present inventive concept may, however, be embodied in different forms and should not be construed as limited to the embodiments set forth herein. Rather, these embodiments are provided so that this disclosure will be thorough and complete, and will fully convey the scope of the present inventive concept to those skilled in the art. Accordingly, the dimensions of elements in the figures may be exaggerated for clarity of illustration.

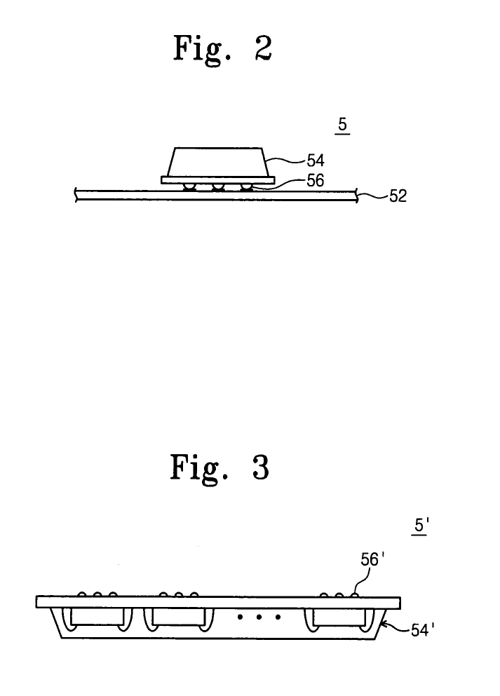

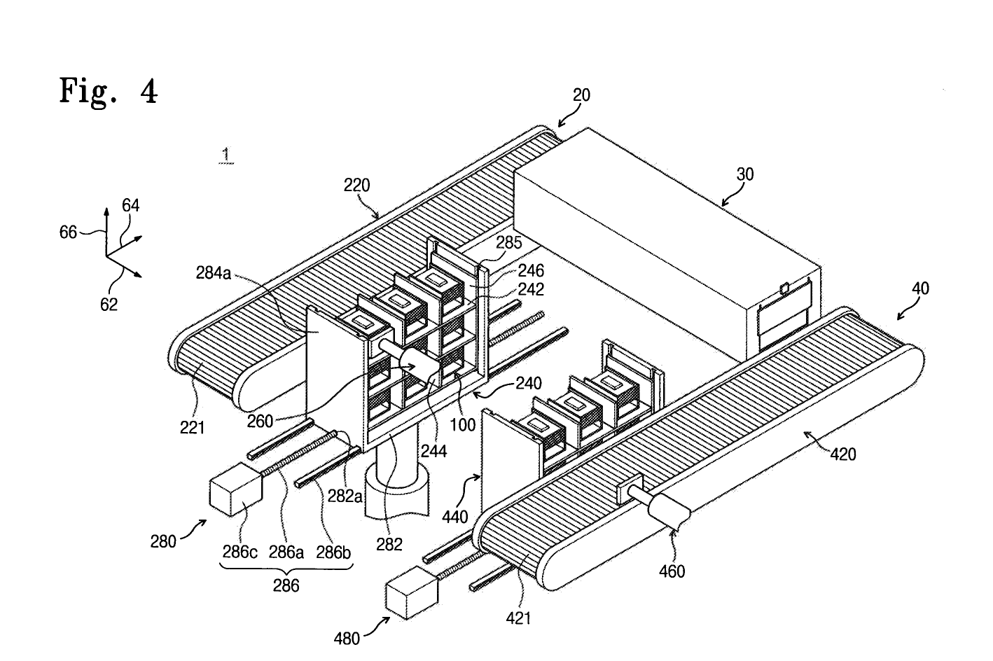

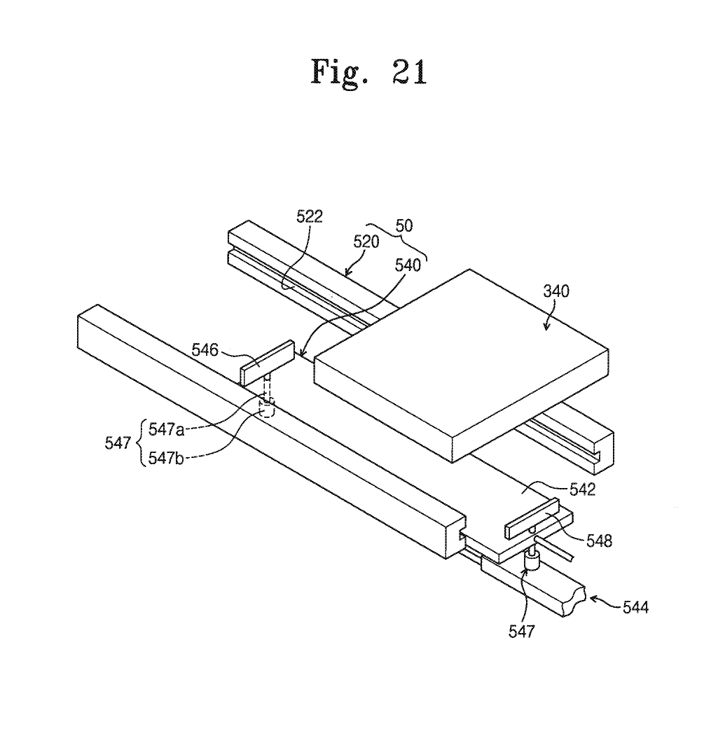

FIG. 1 is a view schematically illustrating the structure of a reflow apparatus 1 according to an embodiment of the present inventive concept. Referring to FIG. 1, a reflow apparatus 1 includes a loader unit 20, a heating unit 30, an unloader unit 40, and a moving unit 50 (shown in FIG. 21). The heating unit 30 performs reflow of external connection terminals (such as solder balls 56 and 56′ in FIGS. 2 and 3, respectively). The loader unit 20 stores a processing object for a reflow process to be performed on, and the unloader unit 40 stores a processing object that has been reflow-processed in the heating unit 30. The moving unit 50 moves the processing object from the loader unit 20 to the heating unit 30, and moves the processing object that has completed the reflow process from the heating unit 30 to the unloader unit 40. Below, for descriptive convenience, the longitudinal direction of the heating unit 30 will be referred to as a first direction 62, a direction perpendicular to the first direction 62 on a horizontal plane will be referred to as a second direction 64, and a vertical direction will be referred to as a third direction 66 (as shown in FIG. 4).

According to some embodiments, a processing object 5 may be a PCB 52 on which a semiconductor chip 54 is mounted through a chip mounting process (as illustrated in FIG. 2). According to other embodiments, a processing object 5′ may be a semiconductor chip 54′ with solder balls 56′ bonded thereon through a ball attach process (as illustrated in FIG. 3). The processing object may be a single semiconductor chip or a plurality of semiconductor chips that are not separated. The processing objects 5 and 5′ of the present inventive concept are not limited thereto, and may be any of various components with external connection terminals utilizing a reflow process, such as a solder ball reflow process.

In the below-described embodiments, descriptions will be given with the processing object 5 generally being a PCB 52 on which a semiconductor chip 54 is disposed. However, the below-described embodiments are applicable to any type of processing object, including for example the processing object 5′.

FIG. 4 is a perspective view of the reflow apparatus 1 of FIG. 1. The magazine 100 stores a plurality of processing objects in a stacked state. The processing objects 5 to be subjected to the reflow process stand by in a stored state near the entrance of the heating unit 30. In the present embodiment, the heating unit 30 employs an induction heating method to perform a reflow process, and thus a high reflow process speed can be achieved. The magazine 100 is suitable for continuously supplying processing objects 5 into the heating unit 30.

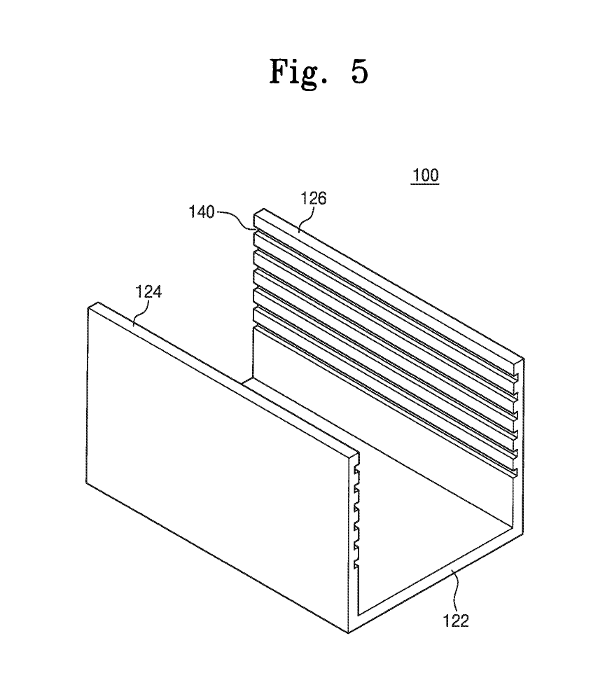

FIG. 5 is a perspective view of an example of a magazine 100. The magazine 100 includes a floor plate 122 and two side plates 124 and 126. The side plates 124 and 126 extend upward from either side of the floor plate 122. The side plates 124 and 126 have a similar shape. The front, rear, and top sides of the magazine 100 are open. The open front and rear sides of the magazine 100 allow the processing objects 5 to be inserted into or withdrawn out from the magazine 100. The space defined between the floor plate 122 and the side plates 124 and 126 is for storing the processing objects 5. Slots 140 are defined in the inner surfaces of each of the side plates 124 and 126, in which the edge regions of the processing objects 5 are inserted. The slots 140 extend from one end to the other end of the inner surfaces of the side plates 124 and 126. The slots 140 are separated in a vertical direction from one another. The objects 5 are stored in the magazine 100 in a stacked configuration, separated from each other due to the separation of the slots 140.

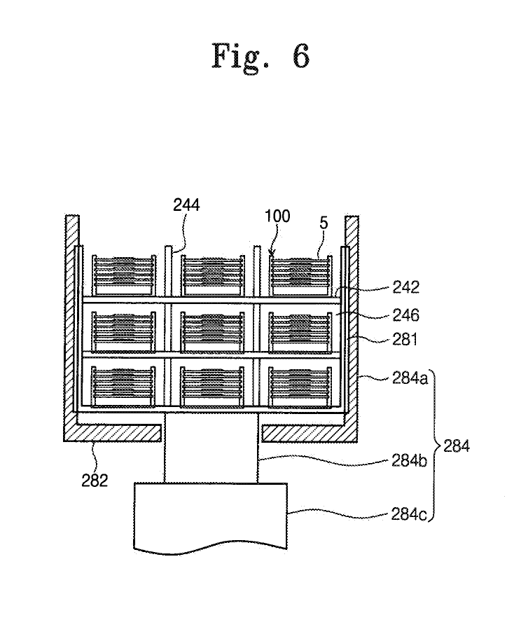

Referring again to FIG. 4, the loader unit 20 includes an input module 220, an input stacker 240, and a stacker moving member 280. FIG. 6 is a cross-sectional view of an input stacker 240. Referring to FIGS. 4 and 6, the input stacker 240 has a plurality of storage spaces 246 in which the respective magazines 100 are stored. The input stacker 240 includes a plurality of horizontal plates 242 and a plurality of vertical plates 244. The horizontal plates 242 function as floors on which the magazines 100 are seated. The vertical plates 242 are arranged at predetermined intervals along the third direction 66. The vertical plates 244 partition the spaces defined between the horizontal plates 242 into a plurality of storage spaces 246. The vertical plates 244 are separated at predetermined intervals from one another along the second direction 64. The horizontal plates 242 and the vertical plates 244 may be integrally formed or formed separately and coupled to one another. In the above-configuration, a plurality of storage spaces 246 is provided in the input stacker 240 along both the second direction 64 and the third direction 66. Each storage space 246 is enclosed by two vertical plates 244 and two horizontal plates 242, and the sides at the front and rear of the storage spaces 246 are open. The front and rear sides of the storage space 246 function as passages through which a magazine 100 enters or exits each of the storage spaces 246. The top of the uppermost storage spaces may be open. One magazine 100 is stored in each storage space 246. Alternatively, a plurality of magazines 100 may be stored in each storage space 246 along the first direction 62.

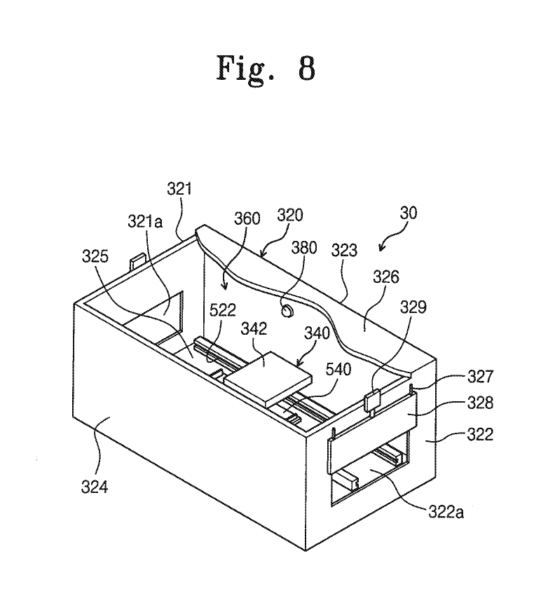

The input module 220 moves the magazine 100 from the input stacker 240 to a position proximate to the entrance 321a (shown in FIG. 8) of the heating unit 30. The input module 220 is disposed longitudinally in the second direction 64. A front region 224 of the input module 220 is proximate to the entrance 321a of the heating unit 30. The input stacker 240 is disposed on the same side of the input module 220 as the heating unit 30. The input stacker 240 is disposed proximate to a rear region 222 of the input module 220. Alternatively, the input stacker 240 may be provided on the side of the input module 220 opposite the heating unit 30. However, to reduce the installation area of the reflow apparatus 1, the heating unit 30, the input module 220, and the input stacker 240 may be arranged as illustrated in FIG. 1.

In one example, a driving member, such as a conveyor belt 221, is provided on the upper surface of the input module 220. The conveyor belt 221 is disposed extending from the rear region 222 to the front region 224 of the input module 220, to enable magazines 100 that have been moved from the input stacker 240 at the rear region 222 of the input module 220 to be conveyed to the front region 224 of the input module 220. While processing objects 5 are being moved individually into the heating unit 30 from the magazine 100 at the front region 224, operation of the conveyor belt 221 is stopped. When all the processing objects 5 of a given magazine 100 have been moved into the heating unit 30, the empty magazine 100 may be removed from the input module 220 by an operator or a moving robot (not illustrated). When the magazine 100 is moved by a moving robot, the magazine 100 may be provided with a supporting member (not shown) that the moving robot can use to support the magazine 100. Also, an aligning member (not shown) for aligning the magazine 100 may be installed at the front region 224 of the input module 220. Once the empty magazine 100 is removed from the conveyor belt 221, the conveyor belt 221 may move so that another magazine 100 is positioned at the front region 224.

According to some embodiments, instead of the conveyor belt 221, a pusher (not shown) may be provided at the rear of the input module 220, to push the magazine 100 from the rear region 222 to the front region 224 of the input module 220. In the above examples, the magazine 100 has been described as being open at both the front and rear sides. However, as an alternative, only one of the four side surfaces of the magazine 100 may be open when the heating unit 30, the input module 220, and the input stacker 240 are arranged as illustrated in FIG. 1.

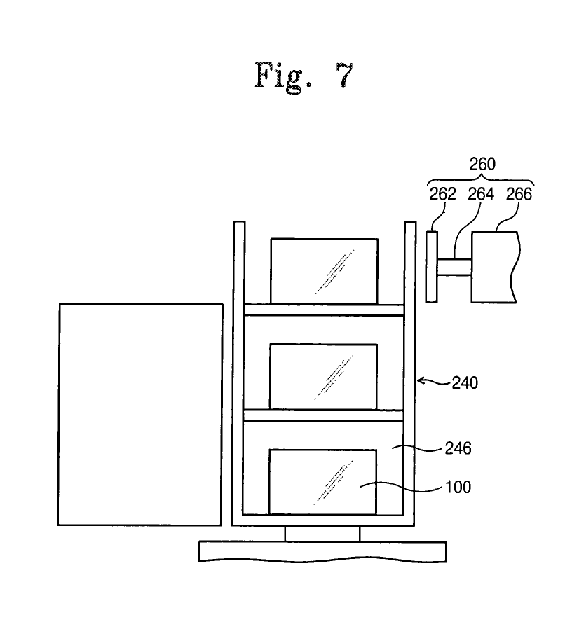

FIG. 7 illustrates an example in which a magazine 100 is moved from an input stacker 240 to a rear region 222 of an input module 220. The magazine 100, with processing objects 5 stored therein, is stored in the storage space 246 of the input stacker 240. A moving member that pushes a magazine 100 stored in the input stacker 240 to the input module 220 is disposed at the side of the input stacker 240 opposite the input module 220. The moving member may employ a pusher 260 having a pushing plate 262. The pushing plate 262 may have an approximately hexahedral shape. A horizontal shaft 264 is connected at the rear surface of the pushing plate 262, and the horizontal shaft 264 is moved linearly in the first direction 62 by means of a cylinder 266 connected thereto. To move the pushing plate 262 quickly, the above-described cylinder 266 may be employed. Alternatively, a motor may be used instead of the cylinder 266. The pusher 260 may be provided as a single pusher or as a plurality of pushers. When provided in a plurality, pushers 260 can be disposed alongside one another in the second direction 64.

To position a storage space 246 (for storing magazines 100 to be moved to the input module 220) so as to correspond to the pusher 260, a stacker moving member 280 moves the input stacker 240 linearly. Referring again to FIGS. 4 and 6, the stacker moving member 280 includes a moving plate 282, a vertical driver 284, and a horizontal driver 286. The moving plate 282 has the shape of a rectangular plate. The vertical driver 284 moves the input stacker 240 linearly in the third direction 66 over the moving plate 282. The vertical driver 284 has guide plates 284a, moving shafts 284b, and motors 284c. The guide plates 284a extend from either end of the moving plate 282 in the third direction 66. Each guide plate 284a defines one or more guide slots 285. The guide slots 285 extend in the third direction 66. The guide slots 285, when viewed from above, are defined in four corners of the input stacker 240, respectively. Protrusions 281 are provided at the outermost vertical plates 244 to couple with guide slots 285 and move in the third direction 66 along the guide slots 285. The moving shaft 284b is fixed and coupled to the front of the input stacker 240, and the motor 284c moves the moving shaft 284b in the third direction 66. A stepping motor may be employed as the motor 284c.

The horizontal driver 286 moves the moving plate 282 linearly in the second direction 64. The horizontal driver 286 includes a screw 286a, horizontal guides 286b, and a motor 286c. The screw 286a is inserted in a screw hole 282a defined in the moving plate 282, and is rotated by the motor 286c. The horizontal guides 286b extend in the second direction 64 at either side of the screw 286a. In the present embodiment, the horizontal driver 286 is described as having a driving assembly employing a screw 286a and a motor 286c; however, a linear motor may be used as an alternative.

The heating unit 30 heats solder balls 56 provided on the processing objects 5 to perform the reflow process. FIG. 8 is a perspective view of an example of a heating unit 30.

A heating unit 30 includes a chamber 320 and a heating member 340. The chamber 320 includes a front wall 321, a rear wall 322, sidewalls 323 and 324, a floor 325, and a ceiling 326. The front wall 321 is adjacent to the input module 220, and the rear wall 322 faces the front wall 321. The chamber 320 is substantially hexahedral, and is formed of a metal such as aluminum for electromagnetic interference (EMI) shielding.

The chamber 320 is provided with a heating chamber 360 within. The heating chamber 360 extends in the first direction 62. The front wall 321 defines an entrance 321a that can function as a passage through which a processing object 5 can pass into the chamber 320, and the rear wall 322 defines an exit 322a that can function as a passage through which a processing object 5 can pass out from the chamber 320. Shutters 328 are provided on the chamber 320 to open and close the entrance 321a and exit 322a, respectively. The shutters 328 are individually moved vertically by a cylinder 329 to open and close the entrance 321a and exit 322a. A guide 327 for guiding the linear movements of the shutters 328 may be provided. The shutters 328 are formed of metal such as aluminum for EMI shielding.

The heating member 340 heats the solder balls 56 using an induction heating method. When alternating current (AC) is applied to a coil, an AC electromagnetic field is generated within the coil. A conductor provided at the region where the electromagnetic field is generated has an eddy current generated in a direction perpendicular to the direction of the electromagnetic field. The eddy current flows along the surface of the conductor and is consumed by generating heat. Induction heating methods use the heat thus generated to heat a processing object.

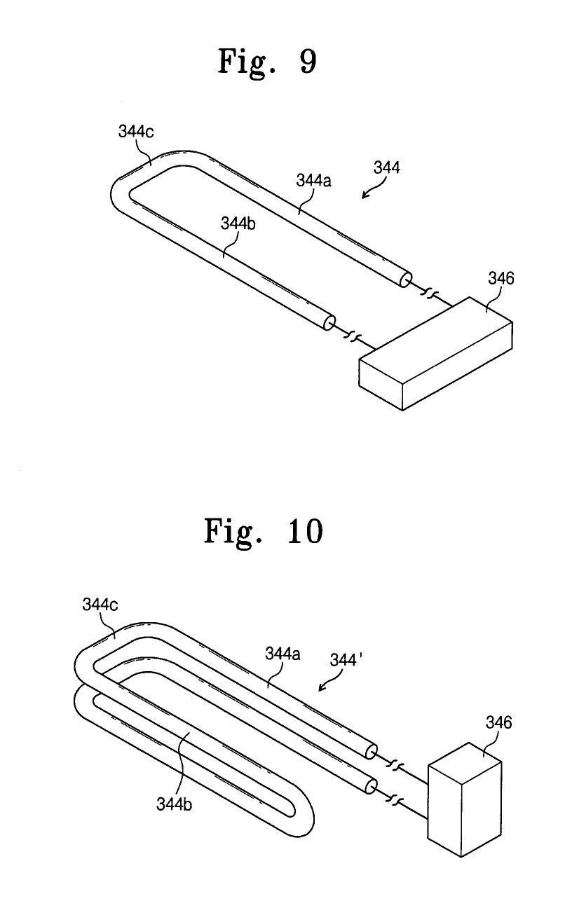

The heating member 340 includes a housing 342, a coil 344 (shown in FIG. 9), and a power supply 346 (shown in FIG. 9). The housing 342 is container-shaped to define a space for accommodating insertion of the coil 344 therein. In one example, the housing 342 has a hexahedral shape. The coil 344 is inserted and fixed within the housing 342. The coil 344 in FIG. 9 includes two straight portions 344a and 344b formed linearly, and a curved portion 344c rounded to connect the straight portions 344a and 344b. The coil 344′ of FIG. 10 may have two connected sets of straight portions 344a and 344b and curved portions 344c. The sets are connected to one another and are provided above and below one another at different levels.

The power supply 346 applies AC current to the coil 344. The current provided may have a frequency ranging from about several tens of kilohertz (KHz) to several megahertz (MHz). The regions heated by the heating member 340 are the portions above and below the regions enclosing the two pairs of straight portions 344a and 344b and curved portions 344c. The heating member 340 is provided in the heating chamber 360.

The reflow process is performed using an induction heating method, and thus the time required for heating is very short. Thus, the reflow process can be performed quickly. Also, when induction heating methods are used, the conductor is heated, while the semiconductor chip 54 or the PCB 52 is not directly exposed to high temperatures. Accordingly, warpage due to thermal deformation of the semiconductor chip 54 or the PCB 52 can be minimized. Further, because the configuration of the heating member 340 is simple and its installation area is small, the overall area of the reflow apparatus 1 can be reduced.

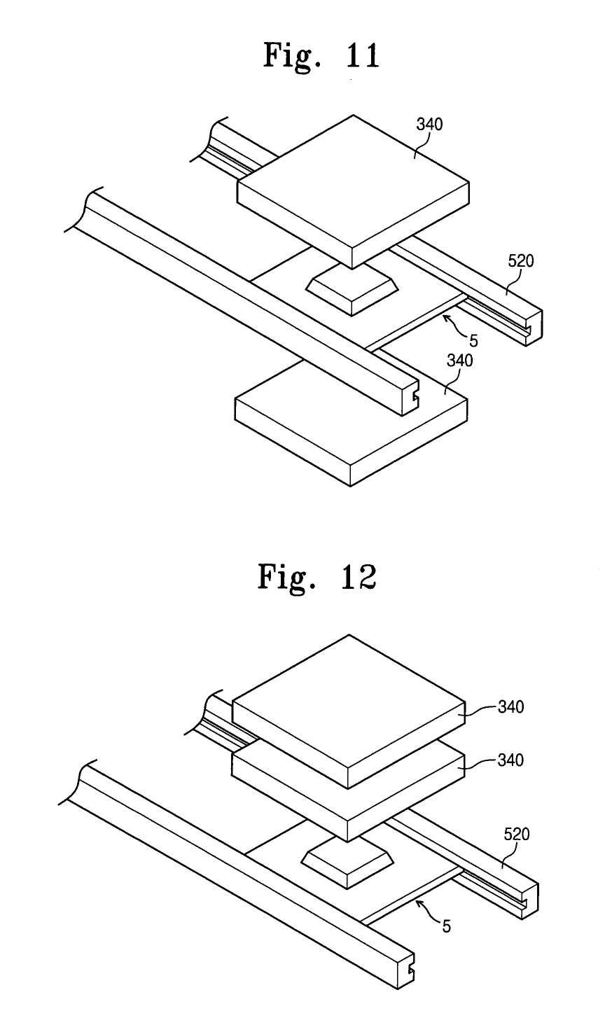

In the above-described examples, the heating member 340 has been illustrated as being disposed above the processing object 5. Alternatively, the heating member 340 may be disposed below the processing object 5. Moreover, as illustrated in FIG. 11, the heating member 340 may be provided in duplicate, with one facing the other from above, and the processing object 5 may be positioned between the two heating members 340. When the heating members 340 are provided in duplicate above and below one another, heating time can be further reduced. Alternatively, as illustrated in FIG. 12, the heating member 340 may include a plurality of stacked heating members disposed above or below the processing objects 5.

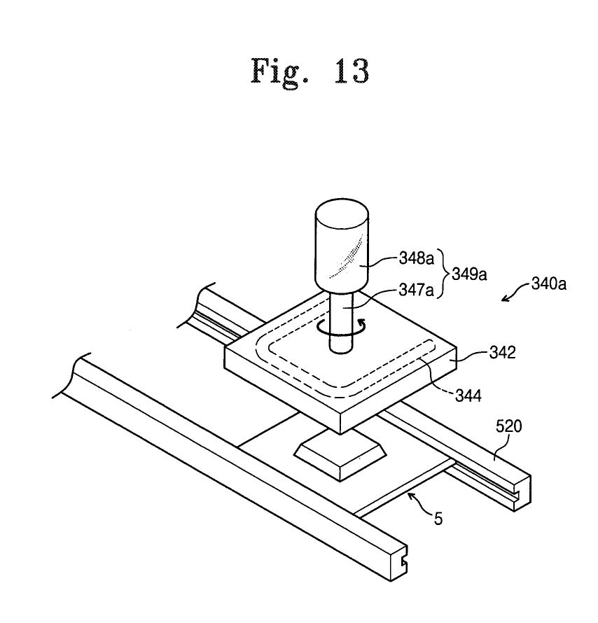

FIGS. 13 through 15 are views illustrating other examples of heating members 340a, 340b, and 340c. The heating members 340a, 340b, and 340c include a housing 342, a coil 344 to which a power supply is connected, and rotating members 349a, 349b, and 349c. The housing 342 and the coil 344 are similar to those described above, and therefore, repetitive descriptions thereof will not be given. The rotating members 349a, 349b, and 349c rotate either the coil 344 or the processing object 5 to alter the relative positions of the coil 344 and the processing object 5. The rotation of the coil 344 may be achieved by rotating the housing 342.

In one example, as illustrated in FIG. 13, the rotating member 349a rotates the coil 344 in a plane in which the coil is disposed. The plane may be a horizontal plane. The coil 344 is fixed and installed in the housing 342, and the housing 342 is provided to be substantially parallel to the processing object 5 to be heated. The rotating member 349a includes a rotating shaft 347a fixed and coupled to the ceiling of the housing 342 in which the coil 344 is fixed and installed, and a motor 347b providing rotational force to the rotating shaft 347a. In general, a plurality of solder balls 56 is provided on a semiconductor chip 54. When heating is performed with the coil 344 fixed, heating of the solder balls 56 may be uneven. However, when heating is performed by rotating the coil 344 in a parallel plane as illustrated in FIG. 13, uniformity in the heating of the solder balls 56 can be improved. The rotating member 349a may continuously rotate the coil 344 in one direction, or rotate the coil 344 in alternating directions. Also, the rotating member 349a may either rotate the coil 344 continuously without stopping, or repeat a cycle of stopping and resuming rotation of the coil 344 at predetermined rotation angles.

In the above-described example, the rotating member 349a has been described as rotating the coil 344. Alternatively, however, the coil 344 may be fixed, and the processing object 5 may be rotated by a rotating member in a plane in which the processing object 5 is disposed. In this case, the structure of the moving unit 50 may be different to that described above. For example, the processing object 5 may be heated while seated on a rotating plate (not shown), and the rotating plate may be rotated while heating is performed. As desired, the coil 344 and the processing object 5 may be rotated in mutually different directions at the same time.

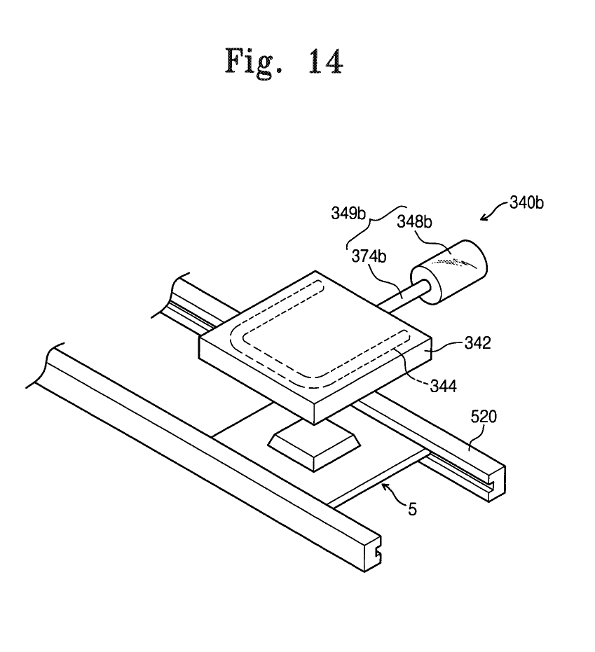

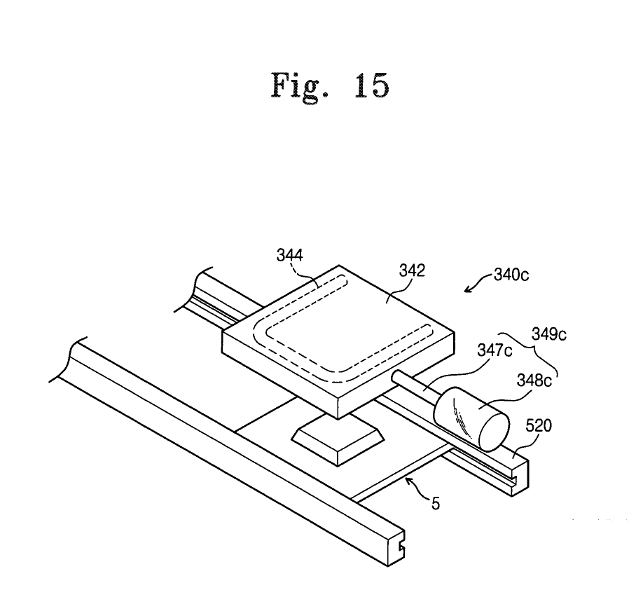

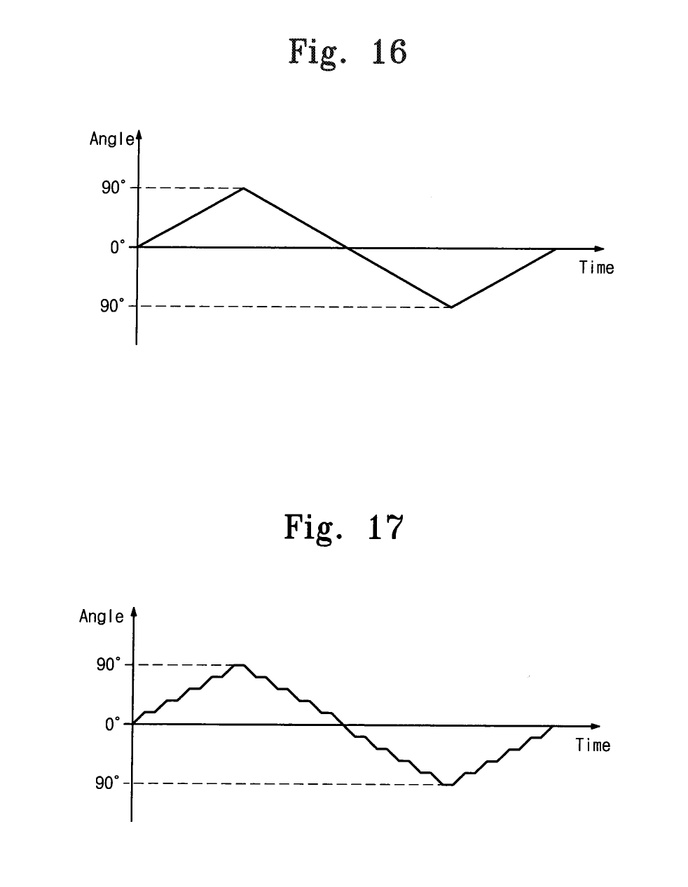

FIGS. 14 and 15 illustrate other examples of rotating members 349b and 349c. The rotating member 349b rotates the processing object 5 so that the angle between the coil 344 and the processing object 5 is varied. The rotating member 349b includes a rotating shaft 347b fixed and coupled at a side of the housing 342 with the coil 344 installed therein, and a motor 348b providing rotational force to the rotating shaft 347b. The rotating shaft 347b may be a shaft that is provided parallel to the processing object 5. As illustrated in FIG. 14, the rotating shaft 347b may be parallel to the two straight portions 344a and 344b of the coil 344 and disposed along a line passing between the straight portions 344a and 344b. Alternatively, the rotating shaft 347c may be disposed along a line perpendicular to the two straight portions 344a and 344b of the coil 344, as illustrated in FIG. 15. With the coil 344 provided parallel to the processing object 5, the coil 344 may be rotated in alternating angles ranging from about −90° to about 90°. As illustrated in FIG. 16, during heating of the processing object 5, the rotating member 349b may continuously rotate the coil 344 without stopping. Alternatively, the rotating member 349b may repeat a cycle of stopping and resuming rotation of the coil 344 at predetermined rotation angles, as illustrated in FIG. 17.

In the above-described example, the rotating member 349b has been described as rotating the coil 344. Alternatively, the coil 344 may be stationary, and the rotating member 349b may rotate the processing object 5 to vary the angle between the coil 344 and the processing object 5. As desired, the coil 344 and the processing object 5 may be rotated simultaneously in mutually different directions.

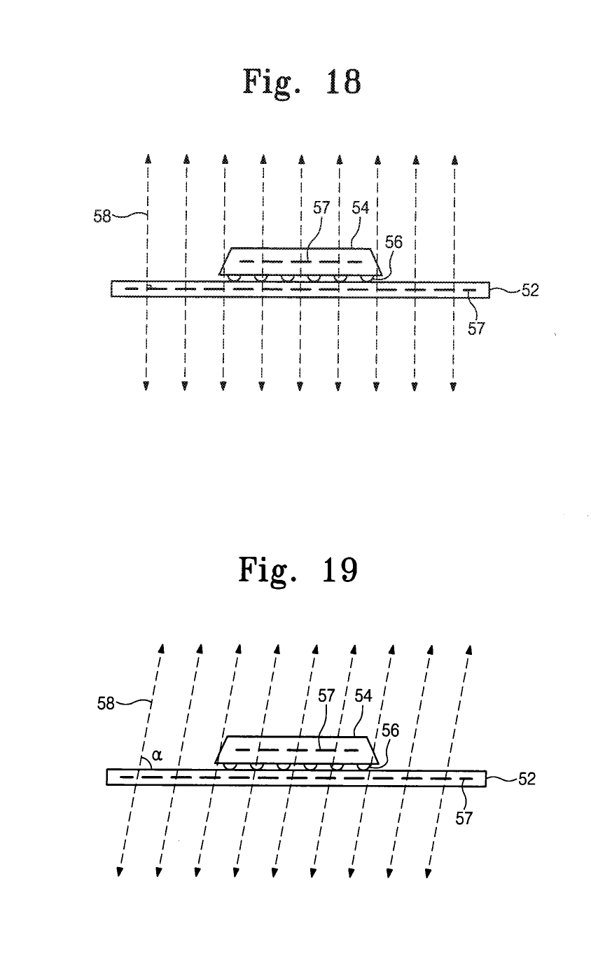

Rotation as illustrated in FIGS. 14 and 15 has the following benefits, referring to FIGS. 18 and 19. A plurality of conductive lines 57 is formed substantially horizontal within the PCB 52 and the semiconductor chip 54. When the coil 344 and the processing object 5 are parallel, the conductive lines 57 provided in the PCB 52 and the semiconductor chip 54 are perpendicular to electromagnetic lines of force 58, as illustrated in FIG. 18, so that the conductive lines 57 are heated to a high temperature. However, when there is an angle (α) between the coil 344 and the processing object 5, as illustrated in FIG. 19, the angle formed between the electromagnetic lines 58 and the conductive lines 57 is offset from a right angle, so that continued heating of the conductive lines 57 to a high temperature can be reduced. Accordingly, the rotation illustrated in FIGS. 14 and 15 can reduce continued heating of the conductive lines 57 to a high temperature while still uniformly heating the entire region of each solder ball 56.

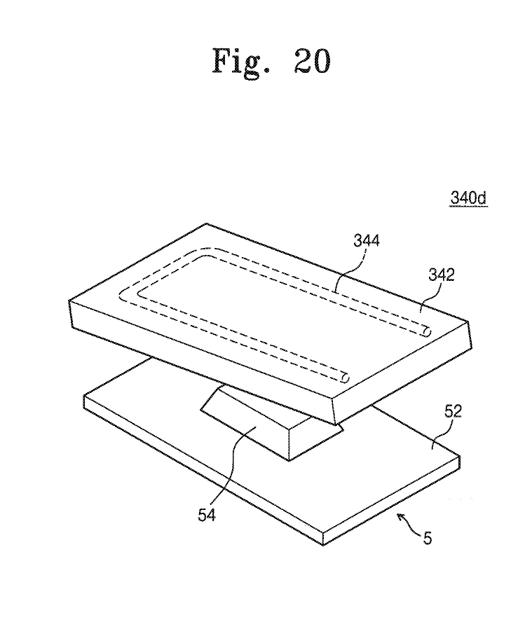

FIG. 20 illustrates another example of a heating member 340d. A coil 344 is fixed and installed within a chamber 320, and the coil 344 is disposed so as to be sloped with respect to a processing object 5 to prevent the conductive lines 57 within the semiconductor chip 54 or the PCB 52 from being heated to a high temperature. Also, with the coil 344 forming a slope with respect to the processing object 5, the coil 344 may be rotated about an axis perpendicular to the processing object 5.

Referring again to FIG. 8, a sensor 380 may be further provided to sense temperatures by region on the processing object 5 being heating by the heating member 340. The sensor 380 senses whether high-speed heating in the heating unit 30 is being properly performed. For example, the sensor 380 may employ an infrared camera to show a visual image of regions of the processing object 5, and a display (not illustrated) that allows an operator to visually inspect the image captured by the infrared camera.

Referring again to FIGS. 1 and 4, the unloader unit 40 stores a processing object 5 that has undergone a reflow process. The unloader unit 40 includes an output module 420, an output stacker 440, and a stacker moving unit 480. The output module 420 is disposed longitudinally in the second direction 64. The front region 424 of the output module 420 is disposed proximate to the heating unit 30. The output stacker 440 is disposed proximate to the rear region 422 of the output module 420 on the same side of the output module 420 as the heating unit 30. The output stacker 440 may be provided at the end of the output module 420 opposite the heating unit 30. To reduce the installation area of the reflow apparatus 1, the heating unit 30, the output module 420, and the output stacker 440 may be disposed as illustrated in FIG. 1. The output module 420, the output stacker 440, and the stacker moving unit 480 of the unloader unit 40 have a similar configuration as the input module 220, the input stacker 240, and the stacker moving member 280, respectively, of the loader unit 20. An empty magazine 100 is positioned at the front region 424 of the output module 420 by an operator or a moving robot. Processing objects 5 that have undergone a reflow process are stored in groups in the magazine 100 positioned at the front region 424 of the output module 420, and a plurality of magazines 100 is stored in the output stacker 440 after having been moved to the rear region 422 of the output module 420. A moving member is disposed on a side of the output module 420 opposite to the output stacker 440. A pusher 460 may be used as the moving member. The pusher 460 pushes a magazine 100 that has been moved to the rear region 422 of the output module 420 to an empty storage space of the output stacker 440. The pusher 460 is configured similar to the pusher 260 of the loader unit 20.

The moving unit 50 moves processing objects 5 from the loader unit 20 to the heating unit 30, and moves processing objects 5 that have undergone a reflow process from the heating unit 30 to the unloader unit 40. FIG. 21 illustrates a moving unit 50 in the heating member 30 of FIG. 8. The moving unit 50 includes a pair of rails 520 and a moving member 540.

The rails 520 are disposed facing one another in parallel within the heating chamber 360. The rails 520 extend in the first direction 62 from a region proximate to the entrance 321a of the heating chamber 360 to a region proximate to the exit 322a of the heating chamber 360. The rails 520 may be guides for guiding linear movement of the processing objects 5. Each rail 520 defines a slot 522 in its inner surface. The slot 522 extends longitudinally from one end of the rail 520 to the other end. The edge regions of the processing objects 5 insert into the slots 522 of the rails 520, and the processing objects 5 move along the slots 522.

The moving member 540 removes processing objects 5 from magazine 100, and moves them along the rails 520. The moving member 540 includes a moving bar 542, an inserting finger 546, and a withdrawing finger 548. The moving bar 542 is formed in the shape of a bar, and is disposed in the heating chamber 360. The moving bar 542 may be disposed in the region below the rails 520. The moving bar 542 moves linearly within the heating chamber 360 in the first direction 62 by means of a driver 544. The driver 544 may employ a cylinder to quickly move a processing object 5. The cylinder may be coupled to the end region of the moving bar 542, which is a region facing the entrance 321a of the heating chamber 360. The inserting finger 546 and the withdrawing finger 548 are coupled to the moving bar 542 to be capable of vertical movement with respect to the moving bar 542. The inserting finger 546 is coupled to the moving bar 542 at the front region of the moving bar 542, and removes a processing object 5 from a magazine 100 and moves the processing object 5 to the heating region. The withdrawing finger 548 is coupled to the moving bar 542 at the rear region of the moving bar 542, and moves a processing object 5 that has been heated from the heating region to a magazine 100 positioned on the front region 424 of the output module 420. The inserting finger 546 is disposed above the moving bar 542, and has a substantially rectangular shape. The inserting finger 546 and the withdrawing finger 548 are moved vertically by a driver 547, respectively. A moving shaft 547a is fixed and coupled to the lower surface of the inserting finger 546, and the moving shaft 547a is coupled to the moving bar 542 to be capable of upward and downward movement by means of the cylinder 547b. The withdrawing finger 548 may have a similar shape to the inserting finger 546, and may be coupled to the moving bar 542 with the same configuration as the inserting finger 546.

Referring to FIGS. 8 and 21, the heating member 340 is disposed at the upper portion of the rails 520, and the moving member 540 is installed at the lower portion of the rails 520. However, the positional relation between the heating member 340, the rails 520, and the moving member 540 may be different. For example, the positions of the heating member 340 and the moving member 540 may be reversed, or both the heating member 340 and the moving member 540 may be provided in the upper portion or lower portion of the rails 520.

A description of the process of moving the processing objects 5 with the moving unit 50 will be provided below. First, the inserting finger 546 and the withdrawing finger 548 are positioned in a first position. The first position refers to one in which the upper ends of the inserting finger 546 and the withdrawing finger 548 are lower than the processing object 5 that is to be moved. The moving bar 542 is moved forward and inserted into the magazine 100. The inserting finger 546 is disposed beyond the position of a processing object 5 within a magazine 100, and the withdrawing finger 548 is disposed beyond the position of a processing object 5 within a heating region. Then, the inserting finger 546 and the withdrawing finger 548 are moved into a second position. The second position refers to one where the upper ends of the inserting finger 546 and the withdrawing finger 548 are higher than the processing object 5 to be withdrawn. The moving bar 542 is moved rearward, so that the inserting finger 546 moves a processing object 5 from the magazine 100 to the heating region, and the withdrawing finger 548 moves a processing object 5 from the heating region to the magazine 100 positioned on the output module 420.

FIGS. 8 and 21 represent one embodiment of the present inventive concept illustrating the structure and form of the moving unit 50; however, the structure and form of the moving unit 50 may be embodied in various other ways. For example, FIG. 21 illustrates the inserting finger 546 and the withdrawing finger 548 coupled to one moving bar 542. Alternatively, the inserting finger 546 and the withdrawing finger 548 may be moved independently from one another.

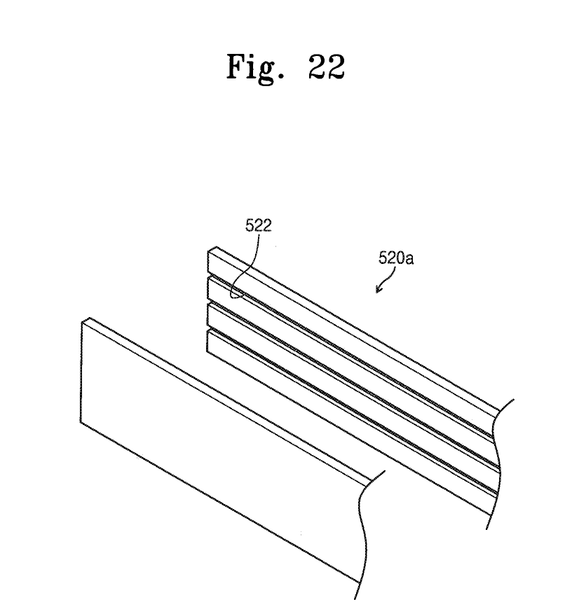

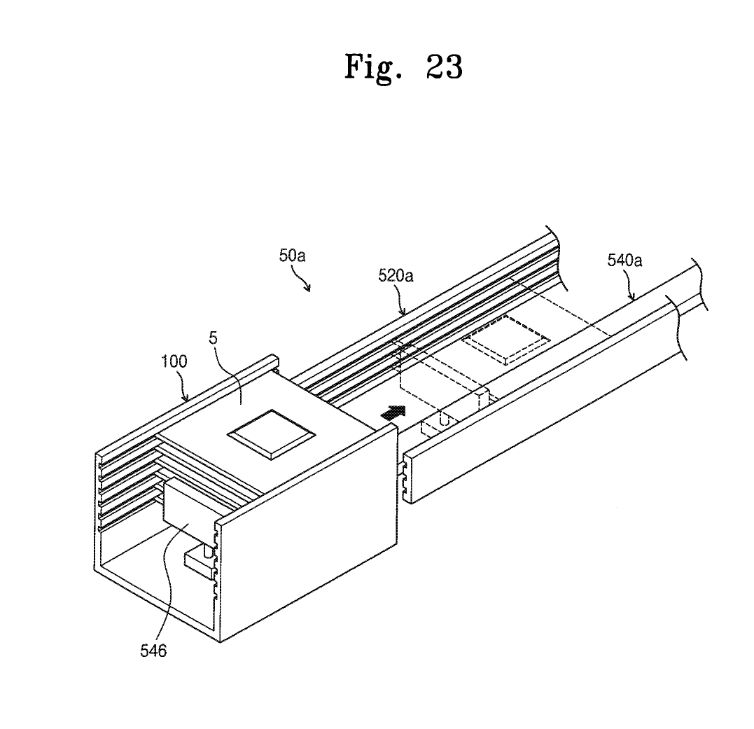

FIGS. 22 and 23 illustrate another example of a moving unit 50a. FIG. 22 is a perspective view of rails 520a, and FIG. 23 illustrates the movement of a processing object 5 moved by means of the moving unit 50a. When employing an induction heating method, heating is performed in a region in which an electromagnetic field is formed. As an electromagnetic field is formed vertically, when processing objects 5 are provided stacked within the heating region, a plurality of processing objects 5 can be heated simultaneously. The moving unit 50a simultaneously moves vertically stacked processing objects 5 to the heating chamber 360, to simultaneously heat a plurality of processing objects 5 within the heating chamber 360. The moving unit 50a includes a pair of rails 520a and a moving member 540a. The pair of rails 520a and the moving member 540a have substantially the same form as the pair of rails 520 and the moving member 540 of the moving unit 50 in FIG. 21. One difference is that the pair of rails 520a has a plurality of slots 522 defined therein. The slots 522 are defined at predetermined vertical intervals apart from each other. The inserting finger 546a and the withdrawing finger (not shown) of the moving member 540a are vertically longer than the inserting finger 546 and the withdrawing finger 548 of the moving member 540 in FIG. 21. Accordingly, as illustrated in FIG. 23, the moving member 540a removes a plurality of processing objects 5 simultaneously from a magazine 100, and moves them simultaneously along a pair of rails 520a.

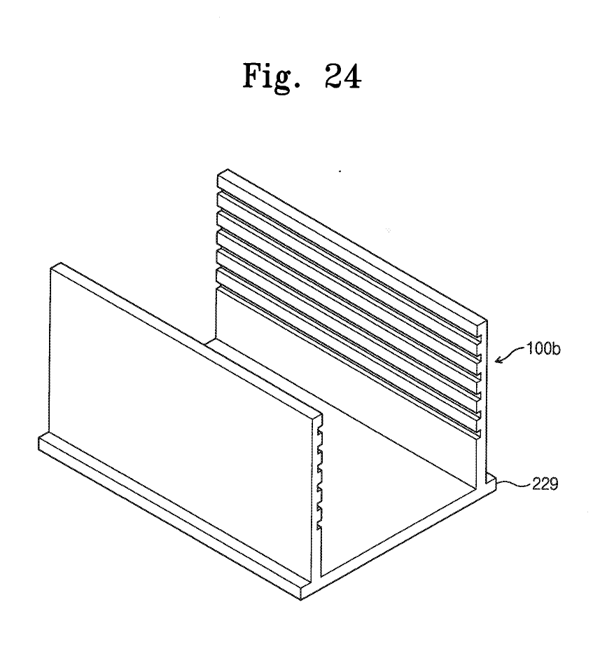

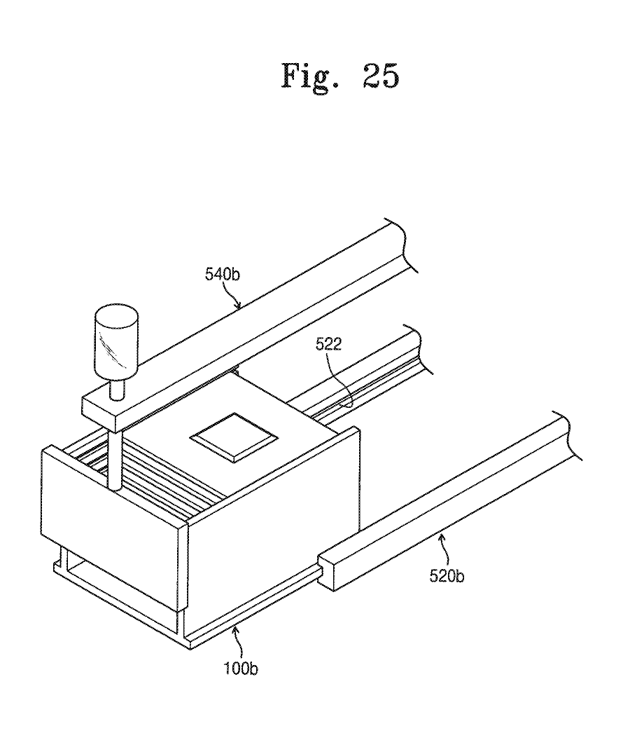

FIGS. 24 and 25 illustrate another example of a magazine 100b and a moving unit 50b for moving the magazine 100b. FIG. 24 is a perspective view illustrating another example of a magazine 100b, and FIG. 25 illustrates a process of moving the magazine 100b in FIG. 24. The moving unit 50b moves a magazine 100b positioned on an input module 220 to a heating unit 30, and moves a magazine 100b within the heating unit 30 to an output module 420. In one example, the moving unit 50b includes a pair of rails 520b and a moving member 540b. The pair of rails 520b and the moving member 540b may have substantially the same configurations as the pair of rails 520 and the moving member 540 in FIG. 21. One difference is that the inserting and withdrawing fingers (not shown) of the moving member 540b are configured to directly move the magazine 100b. As illustrated in FIG. 24, the magazine 100b has a guide protrusion 229 on either sidewall thereof projecting outward. The guide protrusions 229 are formed to be inserted into the slots 522 defined in the rails 520 to move therein. FIG. 25 illustrates a magazine 100b moved directly by a moving member 50 along the rails 520. In FIG. 25, the moving member 540b is disposed above the rails 520b.

When the magazine 100b is moved directly to the heating region, the magazine 100b can be made of a non-metal material. If the magazine 100b were to be made of a metal material, the magazine 100b would also be heated during heating of the processing objects 5 in the heating region. In this case, the magazine 100b might heat the processing objects 5 and cause warpage of the processing objects 5.

In the above example, the guide protrusion 229 is provided on the magazine 100b, and the magazine 100b has been described as being directly inserted in the slots 522 of the rails 520b. Alternatively, a moving plate (not shown) may be provided to be inserted in the slots 522 of the rails 520, and the magazine 100 may be seated and moved thereon.

Referring to FIGS. 23 and 25, when a plurality of processing objects 5 is stacked and moved to the heating unit 30, the heating unit 30 may be provided above and below the processing objects, respectively. This is to improve heating uniformity of the processing objects 5.

Next, a process of performing processing using a reflow apparatus 1 according to an embodiment of the present inventive concept will be described. Below, an example of an apparatus with one processing object 5 moved to a heating chamber 360 will be described. First, with a processing object 5 having been subjected to a chip mounting process or a ball attach process stored in a magazine 100, the magazine 100 (which may be referred to as a load magazine) is positioned in a storage space 246 of an input stacker 240. The input stacker 240 is moved so that the storage space 246, in which a magazine 100 to be subjected to a reflow process is disposed, corresponds to a pusher 260. The pusher 260 pushes the magazine 100 in the input stacker 240 to the rear region 222 of the input module 220. The magazine 100 is moved from the rear region 222 of the input module 220 to the front region 224 thereof. After another magazine 100 is moved from the input stacker 240 to the rear region 222 of the input module 220, it is put on standby at the rear region 222 of the input module 220.

Next, the entrance 321a and/or exit 322a of the heating chamber 360 open. The inserting finger 546 of the moving member 540 removes the processing object 5 stored in the magazine 100 and moves it to the heating region. In the event there is already a processing object 5 in the heating chamber 360, the processing object 5 that was heated in the heating region is stored in a magazine 100 (which may be referred to as an unload magazine) positioned on the output module by the withdrawing finger 548. The entrance 321a and/or exit 322a of the heating chamber 360 are closed, and heating of the processing object 5 is performed. This process is continually repeated while there are more processing objects to be processed.

When all the processing objects 5 are removed from the magazine 100 on the input module 220, the emptied magazine 100 is removed from the input module 220 by an operator or a moving robot (not shown), and the magazine 100 on standby at the rear region 222 of the input module 220 is moved to the front region 224 of the input module 220. When the processing objects 5 that have been subjected to the reflow process are all stored in the magazine 100 at the front region 424 of the output module 420, the magazine 100 is moved to the rear region 422 of the output module 420, after which the magazine 100 is stored in an empty storage space 246 of the output stacker 440.

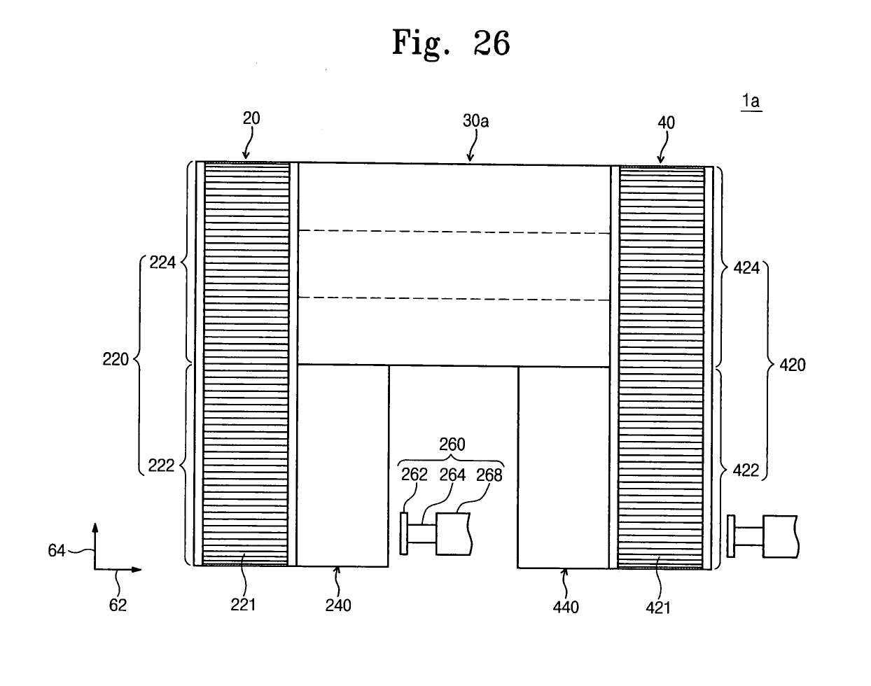

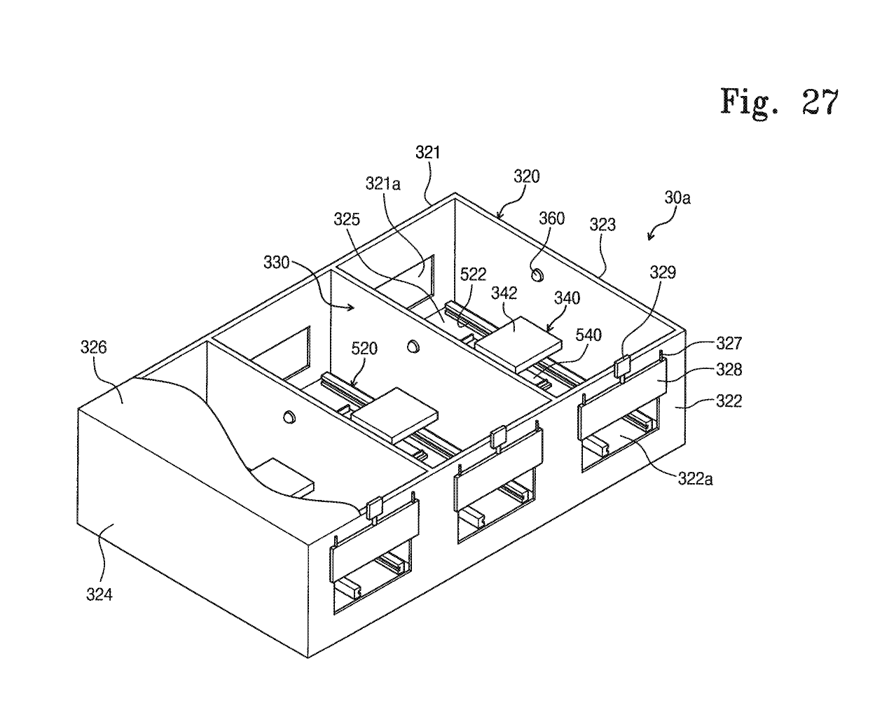

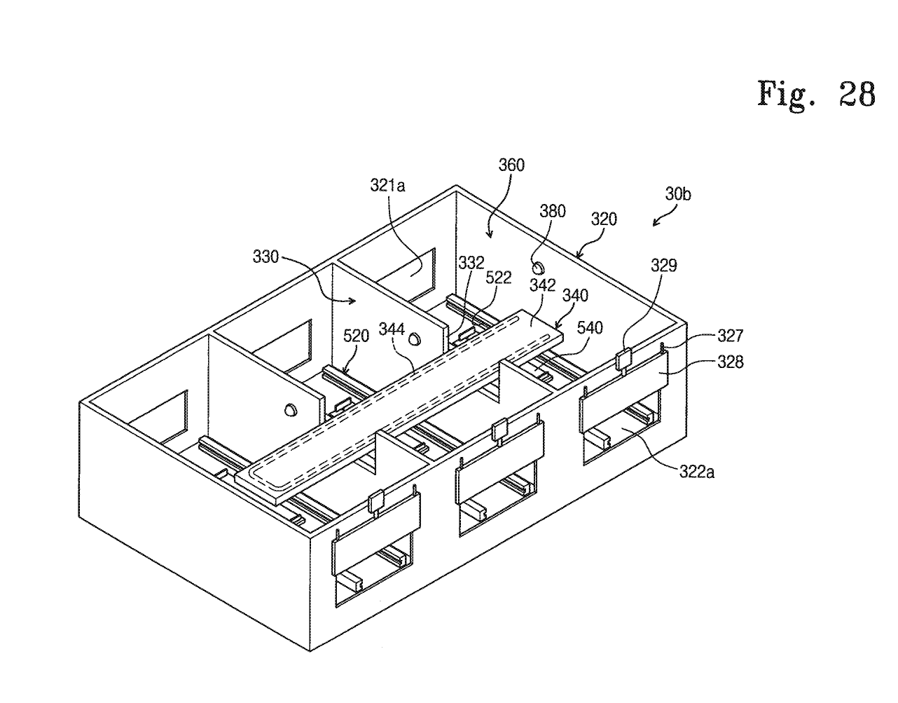

FIG. 26 illustrates the configuration of another example of a reflow apparatus 1a, and FIG. 27 is a perspective view of a heating unit 30a of the reflow apparatus in FIG. 26. Referring to FIGS. 26 and 27, the reflow apparatus la includes a loader unit 20, a heating unit 30a, an unloader unit 40, and one or more moving units (not shown) inside the heating unit 30a. The loader unit 20, the unloader unit 40, and the moving units may have substantially similar configurations as the loader unit 20, the unloader unit 40, and the moving unit 50, respectively, of the apparatus in FIG. 1. The heating unit 30a includes a plurality of heating chambers 360. The heating chambers 360 are arranged proximately to one another in the second direction 64. Each heating chamber 360 may be partitioned by partitions 330 provided parallel to the sidewalls 323 and 324. The input module 220 of the loader unit 20 has a longer front region 224 than the input module 220 in FIG. 1, to position magazines 100 facing respective heating chambers 360. The heating chambers 360 are respectively provided with an entrance 321a and exit 322a that are passages for processing objects. Also, a heating member 340 is separately provided for each of the heating chambers 360, and the moving units are provided in a number corresponding to the number of heating chambers 360.

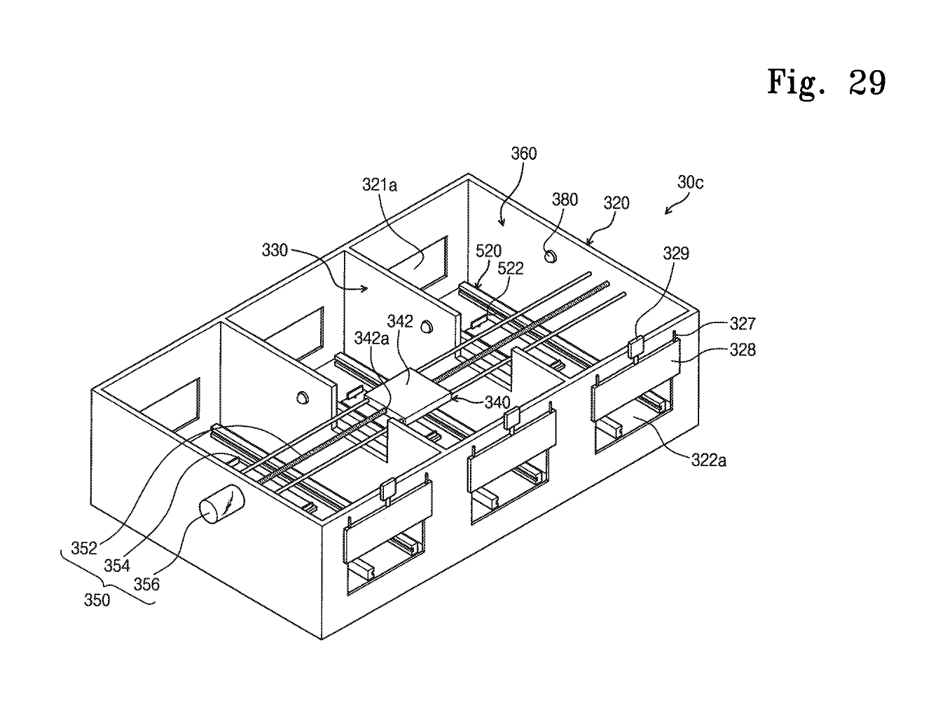

FIG. 28 is a perspective view of another example of a heating unit 30b of FIG. 26. A plurality of heating chambers 360 is arranged in parallel in the second direction 64 in the chamber 320. The heating members 340 are arranged in the second direction 64 to intersect with the plurality of heating chambers 360. The partitions 330 define openings 332 through which a housing 342 is inserted. When the heating unit 30b in FIG. 28 is used, processing objects 5 provided in the plurality of heating chambers 360 may simultaneously be heated using one coil 344 and one power supply 346. Either end of the housing 342 may be fixed and installed at either sidewall 323 and 324 of the chamber 320, respectively. In the case of the heating unit 30b in FIG. 28, it is possible to insert the processing objects 5 into the respective heating chambers 360 at the same time and vary AC current to the coil 344 accordingly. However, when AC current is continuously applied to the coil 344, the processing objects 5 may be inserted in the heating chambers 360, respectively, at different times.

FIG. 29 illustrates another example of a heating unit 30c. The heating member 340 is provided in the chamber 320 to be movable between heating chambers 360 by a heating member mover 350. An opening 332 is defined in each partition 330 to enable the housing 342 to pass through. The heating member mover 350 includes a screw 352, a guide 354, and a motor 356. The screw 352 is provided in the second direction 64 to intersect each of the plurality of heating chambers 360. The screw 352 is disposed to pass through the openings 332 of the partitions 330. The housing 342 defines a screw hole 342a, and the screw 352 is inserted in the screw hole 342a of the housing 342. Also, a guide 354 is respectively provided at either side of the screw 352 parallel to the screw 352. The guides 354 are fixedly installed to the chamber 320, and the housing 342 is coupled to the guides 354 to move linearly along the guides 354. In the heating unit 30c in FIG. 29, it is possible to insert the processing objects 5 in the respective heating chambers 360 at different times. However, even when the processing objects 5 are inserted simultaneously in the respective heating chambers 360, while processing objects 5 are standing by in the heating chamber 360, the heating member 340 can perform the reflow process by sequentially moving between the respective heating chambers 360.

When the apparatus in FIG. 26 is used, the pusher 260 is provided in a number corresponding to that of the heating chambers 360 in the loader unit 20, and a plurality of magazines 100 can be simultaneously moved from the input stacker 240 to the rear region 222 of the input module 220. Then, the magazines 100 disposed at the rear region 222 of the input module 220 may be moved to the front region 224 of the input module 220 simultaneously by means of a conveyor belt 221, etc. Alternatively, one pusher 260 may be provided in the loader unit 20, the input stacker 240 may move in the second direction 64, the magazines 100 may sequentially be moved to the rear region 222 of the input module 220 from the input stacker 240, and the conveyor belt 221 may be continuously operated or operated at intervals until all the magazines 100 are moved to the rear region 222 of the input module 220.

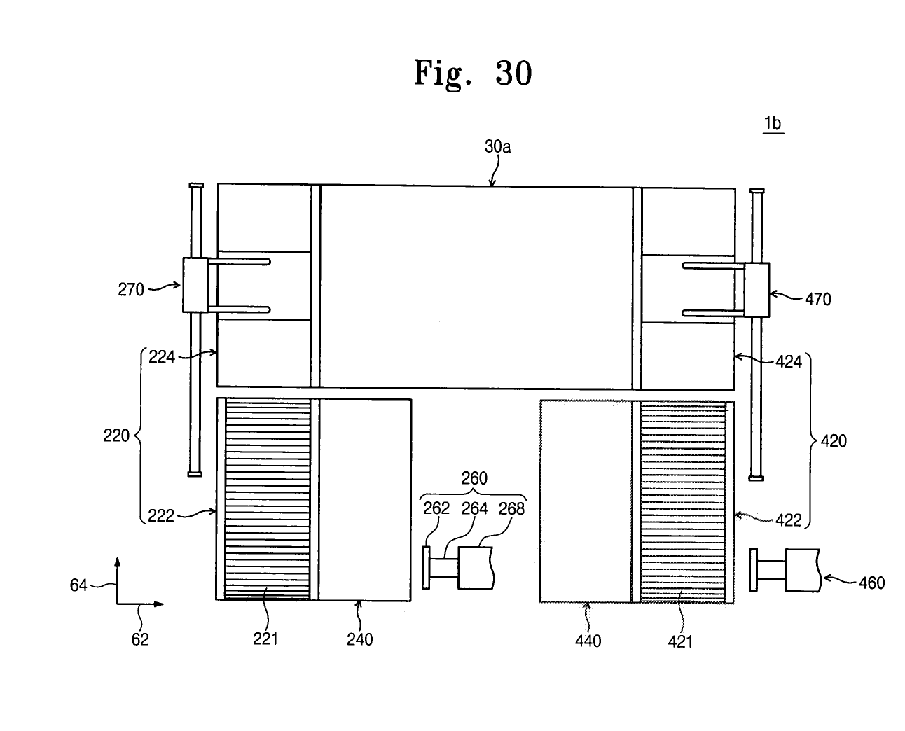

FIG. 30 illustrates another example of a reflow apparatus 1b of FIG. 26. The reflow apparatus 1b can be substantially similar to the reflow apparatus la in FIG. 26, with the exception of the input module 220 and the output module 420. Referring to FIG. 30, moving members such as conveyor belts 221 and 421 are provided only at the rear regions 222 of the input module 220 and the rear region 422 of the output module 420. Moving of magazines 100 from the rear region 222 to the front region 224 of the input module 220 and moving of magazines 100 from the front region 424 to the rear region 422 of the output module 420 may be performed by moving robots 270 and 470, respectively.

Embodiments of the present inventive concept provide apparatuses for performing reflow of external connection terminals provided on a processing object. The reflow apparatus includes a loader unit for simultaneously storing a plurality of processing objects, a heating unit for heating the processing objects with an induction heating method to perform reflow of external connection terminals provided on the processing objects, a moving unit for moving the processing objects from the loader unit to the heating unit, and an unloader unit for storing those of the processing objects that have undergone a reflow process.

In some embodiments, the reflow apparatus may further include a load magazine for storing the processing objects in a stacked configuration. The load magazine may be configured to store a printed circuit board with a semiconductor chip mounted thereon as the processing object. Alternatively, the load magazine may be configured to store a semiconductor chip with solder balls attached thereto as the processing object.

In other embodiments, the loader unit may further include a stacker moving member for vertically moving the input stacker, and a conveying member for moving a load magazine stored in one of the storage spaces of the input stacker to the input module. Also, the unloader unit may include an output module on which an unload magazine, for storing processing objects that have been withdrawn from the heating unit, is positioned, an output stacker including a plurality of storage spaces for storing unload magazines in which processing objects that have undergone reflow process are stored, and a conveying member for moving the unload magazines positioned on the output module to one of the storage spaces of the output stacker.

In still other embodiments, the heating unit may be longitudinally disposed in a first direction, the input module may be longitudinally disposed in a second direction perpendicular to the first direction, such that a front region of the input module is proximate to one side of the heating unit, and the input stacker may be disposed at a rear region of the input module proximate to a side of the input module. The output module may be longitudinally disposed in the second direction, such that a front region of the output module is proximate to the other side of the heating unit and the output module faces the input module, and the output stacker may be disposed at a rear region of the output module proximate to a side of the output module.

In even other embodiments, the moving unit may include a pair of rails extending from positions proximate to the input module to positions past a region heated by a heating member in the heating unit, the rails separated from one another, and a moving member for removing the processing objects stored in the load magazine in the input module from the load magazine, and for moving the processing objects along the rails. The rails respectively may define a slot with a slit shape extending along lengths of the rails, the slots in which edge regions of the processing objects are inserted. Selectively, the rails may respectively define a plurality of slots with slit shapes, the slots vertically separated from one another.

In yet other embodiments, the moving unit may include a pair of rails extending from positions proximate to the input module to positions past a region heated by a heating member in the heating unit, the rails separated from one another, and a moving member for moving the load magazine in the input module along the rails. The load magazine may include guide protrusions projecting outward therefrom, and the rails may respectively define a slot with a slit shape along lengths of the rails, the guide protrusions inserting in the slots.

In further embodiments, the moving member may include a moving bar movably provided horizontally in the heating unit, an inserting finger coupled to the moving bar to be capable of moving vertically with respect to the moving bar, for removing processing objects from within the load magazine, and a withdrawing finger coupled to the moving bar to be capable of moving vertically with respect to the moving bar and separated a predetermined distance from the inserting finger, for withdrawing processing objects that have been heated from the heating unit.

In still further embodiments, the moving unit may comprise a plurality of individual moving units, the individual moving units may be uniformly arranged in a horizontal direction, each of the individual moving units may include a pair of rails extending from positions proximate to the input module to positions past a region heated by a heating member in the heating unit, the rails separated from one another, and a moving member for removing the processing objects stored in the load magazine in the input module from the load magazine and moving the processing objects along the rails, and the heating member may include a plurality of individual heating members corresponding to the respective rails.

In even further embodiments, the moving unit may comprise a plurality of individual moving units, the individual moving units may be uniformly arranged in a horizontal direction, each of the individual moving units may include a pair of rails extending from positions proximate to the input module to positions past a region heated by a heating member in the heating unit, the rails separated from one another, and a moving member for removing the processing objects stored in the load magazine in the input module from the load magazine and moving the processing objects along the rails, and the heating member, when viewed from above, may be disposed to intersect each of the pairs of rails that are respectively provided in each of the moving units to simultaneously heat a plurality of processing objects on the rails.

In yet further embodiments, the moving unit may comprise a plurality of individual moving units, the individual moving units may be uniformly arranged in a horizontal direction, each of the individual moving units may include a pair of rails extending from positions proximate to the input module to positions past a region heated by a heating member in the heating unit, the rails separated from one another, and a moving member for removing the processing objects stored in the load magazine in the input module from the load magazine and moving the processing objects along the rails, and the heating member, when viewed from above, may be provided to be capable of moving between a plurality of the pairs of rails.

In other embodiments, a heating member included in the heating unit may include a coil and a rotating member for rotating the coil or the processing objects.

In yet other embodiments, the rotating member may rotate the coil or the processing objects in a plane that is parallel with a direction of movement of the processing objects through the heating unit.

In still other embodiments, the rotating member may rotate the coil or the processing objects, such that an angle between the coil and the processing objects is varied.

In other embodiments of the present inventive concept, methods for performing a reflow process of solder balls on a processing object, include providing a plurality of processing objects in a stacked formation in a magazine, removing one or a plurality of the processing objects from the magazine, and moving the removed processing object(s) to a heating region, and performing a reflow process on solder balls provided on the moved processing object(s) through employing an induction heating method.

The above-disclosed subject matter is to be considered illustrative, and not restrictive, and the appended claims are intended to cover all such modifications, enhancements, and other embodiments, which fall within the true spirit and scope of the present inventive concept. Thus, to the maximum extent allowed by law, the scope of the present inventive concept is to be determined by the broadest permissible interpretation of the following claims and their equivalents, and shall not be restricted or limited by the foregoing detailed description.

What is claimed is:

1. A reflow apparatus comprising:
a loader unit for storing a plurality of processing objects;
a heating unit for heating the processing objects to perform reflow of external connection terminals disposed on the processing objects;
a moving unit for moving the processing objects from the loader unit to the heating unit; and
an unloader unit for storing those of the processing objects that have undergone a reflow process in the heating unit.

2. The reflow apparatus of claim 1, further comprising a load magazine for storing the processing objects in a stacked configuration, wherein the loader unit comprises an input module on which the load magazine is placed.

3. The reflow apparatus of claim 2, wherein the loader unit further comprises an input stacker comprising a plurality of storage spaces for storing the load magazine.

4. The reflow apparatus of claim 3, wherein the loader unit further comprises:
a stacker moving member for vertically moving the input stacker; and
a conveying member for moving a load magazine stored in one of the storage spaces of the input stacker to the input module.

5. The reflow apparatus of claim 3, wherein
the heating unit is longitudinally disposed in a first direction,
the input module is longitudinally disposed in a second direction perpendicular to the first direction such that a front region of the input module is proximate to a first side of the heating unit, and
the input stacker is disposed at a rear region of the input module proximate to a side of the input module.

6. The reflow apparatus of claim 5, wherein
the unloader unit comprises:
an output module on which an unload magazine, for storing processing objects that have been withdrawn from the heating unit, is placed; and
an output stacker comprising a plurality of storage spaces for storing unload magazines in which processing objects that have been withdrawn from the heating unit are stored; and
a conveying member for moving the unload magazine positioned on the output module to one of the storage spaces of the output stacker,
the output module is longitudinally disposed in the second direction, such that a front region of the output module is proximate to a second side of the heating unit and the output module faces the input module, and
the output stacker is disposed at a rear region of the output module proximate to a side of the output module.

7. The reflow apparatus of claim 5, wherein the input module further comprises a driver for moving the load magazine to the front region of the input module.

8. The reflow apparatus of claim 2, wherein the moving unit comprises:
a pair of rails extending from positions proximate to the input module to positions past a region heated by a heating member in the heating unit, the rails separated from one another; and
a moving member for removing the processing objects stored in the load magazine and moving the processing objects along the rails.

9. The reflow apparatus of claim 8, wherein the rails each define a slot with a slit shape extending along lengths of each of the rails in which edge regions of the processing objects are inserted.

10. The reflow apparatus of claim 9, wherein the rails respectively define a plurality of slots with slit shapes, the slots vertically separated from one another.

11. The reflow apparatus of claim 8, wherein the moving member comprises:
a moving bar disposed horizontally in the heating unit;
an inserting finger coupled to the moving bar so as to be vertically moveable with respect to the moving bar for removing processing objects from within the load magazine; and
a withdrawing finger coupled to the moving bar so as to be vertically moveable with respect to the moving bar and separated a predetermined distance from the inserting finger for withdrawing processing objects that have been heated from the heating unit.

12. The reflow apparatus of claim 2, wherein the moving unit comprises:
a pair of rails extending from positions proximate to the input module to positions past a region heated by a heating member in the heating unit, the rails separated from one another; and
a moving member for moving the load magazine in the input module along the rails.

13. The reflow apparatus of claim 12, wherein the load magazine comprises guide protrusions projecting outward therefrom, and the rails respectively define a slot with a slit shape disposed along lengths of each of the rails, the guide protrusions configured to be inserted in the slots.

14. The reflow apparatus of claim 12, wherein the load magazine comprises a non-metal material.

15. The reflow apparatus of claim 2, wherein the moving unit comprises a plurality of individual moving units, wherein the individual moving units are uniformly arranged in a horizontal direction, wherein each of the individual moving units comprises:
a pair of rails extending from positions proximate to the input module to positions past a region heated by a heating member in the heating unit, the rails separated from one another; and
a moving member for removing the processing objects stored in the load magazine in the input module from the load magazine and moving the processing objects along the rails, and
wherein the heating member comprises a plurality of individual heating members disposed corresponding to the respective rails of the individual moving units.

16. The reflow apparatus of claim 2, wherein the moving unit comprises a plurality of individual moving units, wherein the individual moving units are uniformly arranged in a horizontal direction, wherein each of the individual moving units comprises:
a pair of rails extending from positions proximate to the input module to positions past a region heated by a heating member in the heating unit, the rails separated from one another; and
a moving member for removing the processing objects stored in the load magazine in the input module from the load magazine and moving the processing objects along the rails, and
wherein the heating member is disposed so as to intersect each of the pairs of rails that are respectively provided in each of the individual moving units and to heat a plurality of processing objects on the pairs of rails.

17. The reflow apparatus of claim 2, wherein the moving unit comprises a plurality of individual moving units, wherein the individual moving units are uniformly arranged in a horizontal direction, wherein each of the individual moving units comprises:
a pair of rails extending from positions proximate to the input module to positions past a region heated by a heating member in the heating unit, the rails separated from one another; and
a moving member for removing the processing objects stored in the load magazine in the input module from the load magazine and moving the processing objects along the rails, and
wherein the heating member is configured to move across the pairs of rails.

18. The reflow apparatus of claim 2, wherein the heating unit comprises an induction heating member, the induction heating member comprising:
a coil;
a power supply for supplying an alternating current to the coil; and
a rotating member for rotating at least one of the coil and the processing objects.

19. The reflow apparatus of claim 18, wherein the rotating member rotates the at least one of the coil and the processing objects in a plane that is parallel with a direction of movement of the processing objects through the heating unit.

20. The reflow apparatus of claim 18, wherein the rotating member rotates the at least one of the coil and the processing objects such that an angle between the coil and the processing objects is varied.

21. The reflow apparatus of claim 2, wherein the heating unit comprises an induction heating member, the induction heating member comprising:
a coil fixedly installed at an angle with respect to the processing objects; and
a power supply for supplying an alternating current to the coil.

22. The reflow apparatus of claim 2, further comprising an infrared camera for capturing an image of the processing objects heated in the heating unit.

23. The reflow apparatus of claim 2, wherein each of the processing objects comprises a printed circuit board with a semiconductor chip mounted thereon.

24. The reflow apparatus of claim 2, wherein each of the processing objects comprises a semiconductor chip with attached solder balls.
